(19) United States
(12) Patent Application Publication
(10) Pub. No.: US 2022/0395927 A1
(43) Pub. Date: Dec. 15, 2022

(54) METHOD AND UNIVERSALLY USABLE DEVICE FOR PRODUCING A PREDETERMINED BREAKING LINE, AND PROCESSING SYSTEM COMPRISING SUCH A DEVICE

(71) Applicant: JENOPTIK Automatisierungstechnik GmbH, Jena (DE)

(72) Inventors: Andreas BODE-MOSIG, Jena (DE); Sebastian DIENERT, Jena (DE); Carsten KEIM, Jena (DE); Norbert PREUSS, Jena (DE); Markus REMM, Rosenthal (DE); Andreas SONNEFELD, Laasdorf (DE)

(21) Appl. No.: 17/840,183

(22) Filed: Jun. 14, 2022

(30) Foreign Application Priority Data
Jun. 15, 2021 (DE) 10 2021 115 496.0

(51) Int. Cl. B23K 26/082; B23K 26/382; B23K 26/03; B23K 26/08

(52) U.S. Cl. CPC B23K 26/082; B23K 26/382; B23K 26/032; B23K 26/0884; B23K 2101/006

(57) ABSTRACT

A method and device for producing a predetermined breaking line in a vehicle interior trim part with a scanning laser beam. An actual position of the vehicle interior trim part held in a working plane relative to a laser scanning device is detected by a camera and the actual position of the predetermined breaking line is derived. A stored desired position for a scan figure corresponding to the predetermined breaking line is corrected to an actual position, whereby the predetermined breaking line is produced at a predetermined position on the vehicle interior trim part during scanning of the scan figure. A positional shift of the scan figure becomes possible because a sensor matrix with an upstream diffuser is used, which can detect transmitted components of the laser beam independently of the position of the laser beam along the scan figure.

### PRIORITY CLAIM

The present application claims priority to German Patent Application No. 10 2021 115 496.0, filed on Jun. 15, 2021, which said application is incorporated by reference in its entirety herein.

### FIELD OF THE INVENTION

The invention relates to a method, a device for producing a predetermined breaking line in a vehicle interior trim part, preferably an airbag cover, said device being suitable for universal use in a production line.

Here, universal use of the device means that it is suitable in combination with various feed devices, even multiple feed devices, including devices of different feed accuracy and for the production of predetermined breaking lines of different contours. The device contains a sensor matrix and a laser scanning device using which, during processing of the vehicle interior trim part, a laser beam scanning over the vehicle interior trim part ablates a material along a predetermined breaking line until a portion of the laser beam transmitted through the vehicle interior trim part is detected by the individual sensors of the sensor matrix.

The invention also relates to a processing system including a device according to the invention and two feed devices.

It should be noted that, for the purposes of this description, a line along which the predetermined breaking line is generated is referred to as a predetermined breaking line, irrespective of the processing state.

### BACKGROUND OF THE INVENTION

The production of predetermined breaking lines in vehicle equipment elements, e.g. for airbag openings in the dashboard, in the door trim or in the steering wheel hub or as breaking points on components protruding into the passenger compartment, such as cup holders, by means of lasers, has long been known. Due to the high requirements, on the one hand, for them to break open reliably if necessary and, on the other hand, for an aesthetic appearance of the equipment parts, so that a vehicle occupant should not perceive the predetermined breaking openings with the naked eye, material removal is performed in a sensor-monitored or sensor-controlled manner along a predetermined breaking line circumscribing the predetermined breaking openings.

It is also known for other applications, e.g. in the packaging industry, to introduce predetermined breaking lines as separating aids in containers and the like by means of lasers.

In order to create a predetermined breaking line by laser material removal, slots or holes which do not extend completely through the vehicle interior trim part, or so-called microperforation holes which penetrate the vehicle interior trim part only with a very small hole, are introduced into the vehicle interior trim part along a predetermined line. By means of the sensor monitoring or sensor control, respectively, either a reproducible remaining defined residual wall thickness or small holes with a reproducible diameter can be produced here, along the line forming the predetermined breaking line, by using the exceeding of a specified threshold value as a control parameter when detecting radiant energy transmitted through the residual wall or the hole. For this purpose, at least one sensor is arranged on a side of the vehicle interior trim part opposite the laser (visible side), which sensor detects, during processing, a transmitted part of the processing laser beam if the vehicle interior trim part only has a specific residual wall thickness or already has a microhole within the predetermined breaking line at the respective processing point. The necessary relative movement for the generation of predetermined breaking lines can basically be generated by the laser beam as a tool or by the vehicle interior trim part, when the tool is stationary, with the movement of the laser beam having proved to be easier to put into practice. Compared to robot-controlled guidance of a laser source above and along the predetermined breaking line, two or three-dimensional scanning of a laser beam along the predetermined breaking line is technically easy to implement and also permits significantly faster processing.

DE 10 2018 129 329 A1 discloses a method for paint-removing laser processing of a painted workpiece using a laser processing device, and also discloses the laser processing device. The workpiece is placed in a working area of the laser processing device, and a position and/or an orientation of the workpiece is detected by a sensor element of the laser processing device. Values for operating parameters of the laser processing device can then be generated, which operating parameters can be generated as a function of the detected position and/or the detected orientation. A laser beam is generated by the laser processing device according to the generated values and the workpiece is impacted with the laser beam. The laser beam is moved in such a way that material of a color coating layer is removed along a working path.

DE 10 2005 026 906 A1 discloses an interior trim part for vehicles and a method for manufacturing such an interior trim part. A device for carrying out the method comprises a laser with focusing optics and a scanner mirror system. A focus of a laser beam generated by the laser is located at a depth in the interior trim part, and material is removed at the focus.

DE 10 2017 112 072 A1 discloses a device and a method for partially removing a coating applied to a vehicle wheel. In the method, a surface on the vehicle wheel is exposed to a processing beam generated by a radiation source and emerging from a processing head until at least part of the coating in the area of the surface is thermally destroyed.

DE 10 2005 054 607 A1 discloses a method for determining a residual layer thickness when forming blind holes or kerfs in components, wherein blind holes or kerfs are formed by means of laser radiation starting from one side of a component and the temperature on the opposite surface of the component is determined without contact by means of electromagnetic radiation emitted from this surface, and the residual layer thickness in the respective processing area of the laser radiation is thus determined.

A method disclosed in the patent specification EP 1 118 421 B1 describes the production of a predetermined breaking line consisting of perforation holes by means of pulsed or continuous laser radiation. Processing optics direct the laser beam onto the rear surface of a vehicle interior trim part. Opposite the front surface of the vehicle interior trim part, a sensor is located in the beam path of the laser, i.e. on the optical axis of the processing optics. During a relative movement between the vehicle interior trim part and the processing optics along a predetermined breaking line to be generated, the laser emits a limited sequence of individual pulses, which partially overlap on the vehicle interior trim part, or continuous laser radiation of limited duration. This creates a slot with a continuously decreasing residual wall thickness in the vehicle interior trim part. The laser radiation is interrupted as soon as the sensor detects a breakthrough of the laser radiation on the front surface. If the required relative movement is to be performed by the laser, high-precision tracking of the sensor must be implemented so that the sensor axis and the optical axis of the processing optics always coincide.

Also according to EP 0 827 802 B1, a defined material removal down to a remaining residual wall thickness (material thickness) is ensured by detecting the transmitted radiation at the processing location from the outside by means of a sensor. For this purpose, the sensor must be located on the optical axis of the laser beam directed at the vehicle interior trim part. No details are given here on the implementation of the relative movement between the laser beam and the vehicle interior trim part required to generate the predetermined breaking line.

EP 3 321 024 A1 discloses a method and a device for producing a tear line in a flat workpiece along a predetermined contour by material removal using a laser. In the method, a workpiece is placed in a working area between an array of sensors and a laser scanner. The laser scanner scans a pulsed laser beam across a rear surface of the flat workpiece, along a tear line, causing material removal in the form of holes, each down to a predetermined residual wall thickness, at a plurality of removal locations along the tear line. Measurement signals generated by a portion of the laser beam transmitted at the removal locations are acquired by individual sensors during material removal. Subsequently, a comparison signal is formed which is compared with a reference signal to which the predetermined residual wall thickness is assigned. The laser generator generating the laser pulses is controlled such that laser pulses impinge on the removal locations only until the predetermined residual wall thickness has been achieved. The transmitted laser radiation power of a laser pulse is detected when it is above a lower limit of the sensitivity range of the sensor, and the tear line can be positioned anywhere within a field of view of the array of sensors. In the disclosed method, no cameras and image-processing methods are provided for optically monitoring the positioning of workpieces to be processed and, if necessary, adjusting the target processing data to the actual situation. Furthermore, no comparative measured values are formed from the measured values acquired at the same time.

Prior art devices are also known with a sensor arrangement that simulates the contour of the predetermined breaking line. The linear sensor arrangement and the workpiece to be processed remain stationary here and a laser beam is guided along the predetermined breaking line. For the same reproducible residual wall thickness on several identical vehicle interior trim parts, these must each be arranged exactly in an identical position relative to the sensor arrangement.

DE 10 2012 109 245 B3 discloses a method and a device for processing non-rotationally symmetrical workpieces by means of laser radiation. The device can have several feeding means, processing means or clamping means, which can be operated parallel to each other, whereby several workpieces or alternating workpieces can be fed to a processing means.

DE 10 2019 133 745 A1 discloses a manufacturing system for laser-machining a workpiece and a method for manufacturing a laser-processed workpiece. One embodiment of the device has a positioning device, which can be designed, for example, as a multi-axis robot and which is set up to position a batch of a plurality of workpieces, in particular a batch of a plurality of workpieces arranged on a workpiece carrier, relative to a laser processing device. An existing transfer system may include a robotic system with at least one multi-axis robot.

According to EP 0711 627 B1, one embodiment of a device disclosed therein includes an ultrasonic sensor that covers the working area of the laser beam and therefore does not need to be moved along, but can remain stationary. The vehicle interior trim part to be processed is placed on the ultrasonic sensor during the creation of a predetermined breaking line by means of a laser, and the laser beam is guided along the desired predetermined breaking line, with the ablation taking the form of a continuous groove or a series of perforation holes (blind holes). For example, the laser beam should be moved by a system of position-controlled, movable mirrors (which would be given by a scanner), or the laser generator is attached to a robot arm manipulator.

The ultrasonic sensor acquires signals corresponding to the thickness of the material that remains as a residual wall after notching by means of the laser beam, and thus provides a feedback signal to the central computer to change the position of the laser generator and/or its output power in order to control the thickness of the residual wall. As an advantage over a solution according to EP 0 711 627 B1, it is stated that this solution allows movement of the laser beam alone, which enables a higher positioning speed between the laser beam and the respective processing location on the predetermined breaking line, if necessary. However, unrestricted practical operation of an extended ultrasonic sensor in a device according to EP 0 711 627 B1 seems doubtful. A prerequisite for this would be at least that the sensor surface is in air-free contact with the surface of the vehicle interior trim part. This is particularly difficult if the surface of the vehicle interior trim part is a three-dimensional free-form surface or if its surface has a structured height profile.

DE 10 2007 024 510 B3 discloses a device with a sensor arranged on the outside of the vehicle interior trim part to be processed, the measuring range of which covers the entire predetermined breaking line. The sensor here is a matrix camera whose pixels can be read out individually. An associated control and computing unit is signal-connected to the sensor and a laser generator that generates the processing laser radiation. The control and computing unit is configured to store the location data of the pixels of the matrix camera assigned to the individual processing locations in order to read out only those pixels during processing that are assigned to the relevant processing location.

The vehicle interior trim part must be positioned in accordingly precise alignment with the sensor so that the individual processing locations along the predetermined breaking line assume a predetermined relative position to the respectively assigned pixels.

This document only discloses the design of the matrix camera as a CMOS camera.

Advantageously, instead of only one matrix camera, several matrix cameras should be arranged whose measuring ranges each cover partial areas of the predetermined breaking line.

According to the method described in the above-mentioned DE 10 2007 024 510 B3, a predetermined breaking line is produced in a vehicle interior trim part, wherein a laser beam is directed onto an inner side of a vehicle interior trim part held stationary in a holding device, is guided along a predetermined breaking line and material removal in the form of holes with a residual wall thickness is effected at a plurality of processing locations along the predetermined breaking line. In this process, measured values of predetermined pixels of a stationary sensor detecting the complete course of the predetermined breaking line on the outside of the vehicle interior trim part are acquired, said measured values being equivalent for the residual wall thickness. Depending on the measured values, a laser generator emitting the laser beam is controlled in comparison with at least one reference measured value. An essential feature of the method disclosed in the above-mentioned DE 10 2007 024 510 B3 is that only predetermined pixels of a matrix camera are read out to determine the measured values. The predetermined pixels are the pixels which are stored as receptive pixels assigned to the individual processing locations.

A disadvantage of the aforementioned method is that the vehicle interior trim part to be processed must be arranged exactly in relation to the sensor, which means that more time is required to feed the vehicle interior trim part into a device for producing a predetermined breaking line.

### SUMMARY OF THE INVENTION

It is an object of the invention to develop a method by which the ratio between the working time of the laser generator and the auxiliary times necessary for carrying out the method is improved in favor of the working time of the laser generator.

It is also an object of the invention to find a device suitable for this purpose and a processing system with such a device, which further improves productivity enhanced by the device.

In terms of a method, the object is achieved by a method for producing a predetermined breaking line in a vehicle interior trim part, wherein the vehicle interior trim part is picked up and arranged in a working plane between a sensor matrix and a processing head arranged in a defined manner thereto and containing a laser scanning device, the laser scanning device scans a laser beam on an inner side of the vehicle interior trim part, describing a scan figure, along the predetermined breaking line, wherein material removal in the form of holes is effected in each case down to a predetermined residual wall thickness at a plurality of processing locations along the predetermined breaking line and measured values are acquired by individual sensors of the sensor matrix during the material removal caused by a portion of the laser beam transmitted at the processing locations, a comparative measured value is formed in each case from simultaneously acquired measured values, which comparative measured value is compared with a reference measured value to which the predetermined residual wall thickness is assigned, and a laser generator emitting the laser beam is controlled as a function of a comparison result. In this context, it is essential to the invention that the measured values of all individual sensors are acquired which lie above a predetermined threshold value, which means that the predetermined breaking line can be positioned anywhere within a field of view of the sensor matrix, that an actual position of the vehicle interior trim part relative to the laser scanning device is optically detected and an actual position of the predetermined breaking line relative to the laser scanning device is derived therefrom, and that a desired position of a scan figure stored for a desired position of the predetermined breaking line for scanning the predetermined breaking line is corrected to an actual position of the scan figure, whereby the predetermined breaking line is produced at a predetermined position on the vehicle interior trim part during scanning of the scan figure.

Advantageously, the method is carried out on three vehicle interior trim parts with a time overlap, arranging the vehicle interior trim parts one after the other in the working plane by two feeding means and determining an actual position of the scan figure individually for a respective actual position of the respective vehicle interior trim part.

Preferably, the first of the three vehicle interior trim parts is processed while held in the first of the two feeding means, while the second feeding means transports the finished second vehicle interior trim part to an output location, and then the third vehicle interior trim part, which has not yet been processed, is picked up at an input location and transported for processing.

Advantageously, the transmitted part of the laser beam is scattered so that measured values can be acquired by more individual sensors.

The object for a device is achieved by a device for producing a predetermined breaking line in a vehicle interior trim part, said device containing a sensor matrix, a processing head arranged in a defined manner with respect to the sensor matrix, said processing head containing a laser scanning device, which is connected to a laser generator, and an intermediate working plane, in which the vehicle interior trim part to be processed is arranged, as well as a control and computing unit. In this case, a field of view of the sensor matrix is larger than a maximum extension of a predetermined breaking line. There is a camera directed towards the working plane, which is configured to detect the actual position of the vehicle interior trim part arranged in the working plane in relation to the laser scanning device and to derive therefrom the actual position of the predetermined breaking line, and the control and computing unit is configured to bring the scan figure into alignment with the predetermined breaking line. It is essential to the invention that a diffuser is arranged upstream of the sensor matrix.

Advantageously, the individual sensors of the sensor matrix each have a sensitivity that is matched to each other so that the sensor matrix has a homogeneous sensitivity.

In terms of a processing system, the object is achieved by a processing system comprising a device according to the invention for producing a predetermined breaking line in a vehicle interior trim part in that it contains at least two feeding means by which a vehicle interior trim part is alternately transported and positioned in the working plane of the device for producing a predetermined breaking line.

Advantageously, the at least two feeding means include multi-axis robots, each robot holding the vehicle interior trim parts suspended in the working plane.

It is essential to the invention that, for exact production of a predetermined breaking line in a predetermined position on the vehicle interior trim part, the vehicle interior trim part to be processed only has to be held roughly in a working plane, which shortens the feed time of the vehicle interior trim part.

Since all the individual sensors of the sensor matrix that form a measurement signal above a threshold value are read out, it is not necessary to position the vehicle interior trim part precisely in relation to the sensor matrix. Instead, a scan figure describing the predetermined breaking line is aligned with the vehicle interior trim part.

### BRIEF DESCRIPTION OF THE DRAWINGS

The invention will be explained in more detail below with reference to exemplary embodiments and drawings. In the drawings:

FIG. 1 is a schematic representation of a device for producing a predetermined breaking line in a vehicle interior trim part, and

FIG. 2 shows a processing system comprising a device according to FIG. 1 and two feeding means.

### DETAILED DESCRIPTION

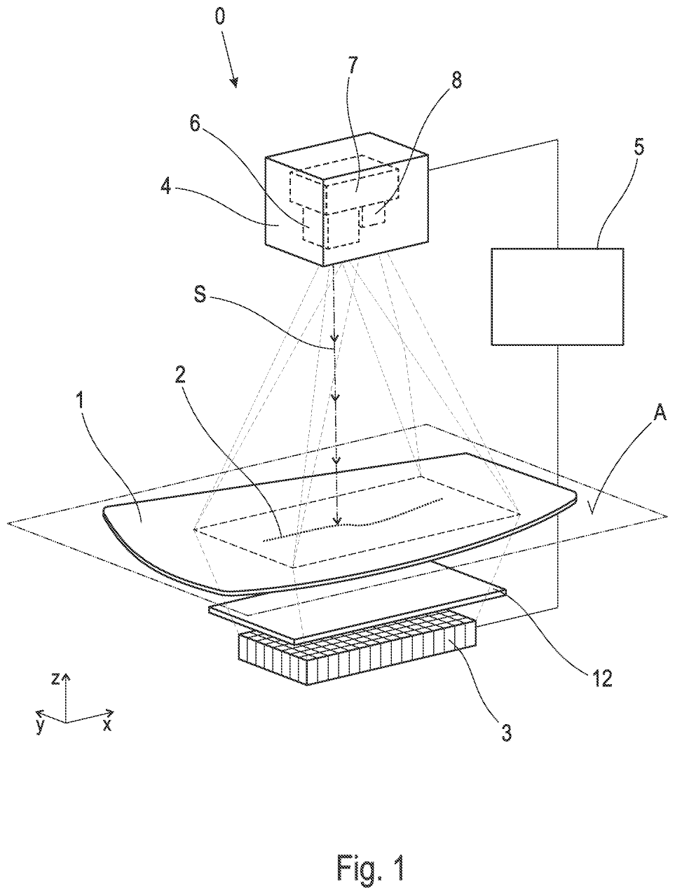

FIG. 1 shows a schematic representation of a device according to the invention for producing a predetermined breaking line 0 in a vehicle interior trim part 1. Said device contains a sensor matrix 3, a processing head 4 arranged in a defined manner with respect to it and an intermediate working plane A in which the vehicle interior trim part 1 to be processed is arranged, as well as a control and computing unit 5, which may include a controller and a computer or a combination thereof. The working plane A is adapted to the surface contour of the vehicle interior trim part 1 and need not be a geometric plane. The processing head 5 contains a laser generator 7, or is connected to a laser generator 7, as well as a laser scanning device 6 and a camera 8 fixed with respect to the laser scanning device 6. The laser generator 7, the laser scanning device 6 and the camera 8 are connected to the control and computing unit 5 via signals.

A field of view of the camera located in the working plane A advantageously covers at least one field of view of the sensor matrix located in the working plane A. Advantageously, both fields of view in the working plane A are of equal size and completely cover each other. A scanning range of the laser scanning device, determined by the maximum deflection of a laser beam S emitted by the laser generator 7, in the x and y directions of a scanner coordinate system, is matched to the size of the field of view of the sensor matrix so that said field of view can be scanned as completely as possible. The camera 8 and the laser device 6 are fixedly connected to each other, whereby a camera coordinate system of the camera has a fixed, known relative position to the scanner coordinate system of the laser scanning device and whereby the image coordinates of each image point of an image generated by the camera 8 can be assigned to the scan coordinates of a scanner position of the laser scanning device 6, respectively.

For the complete creation of a predetermined breaking line 2 with a device according to the invention, the field of view of the sensor matrix must be larger than the maximum extension of a possible predetermined breaking line 2.

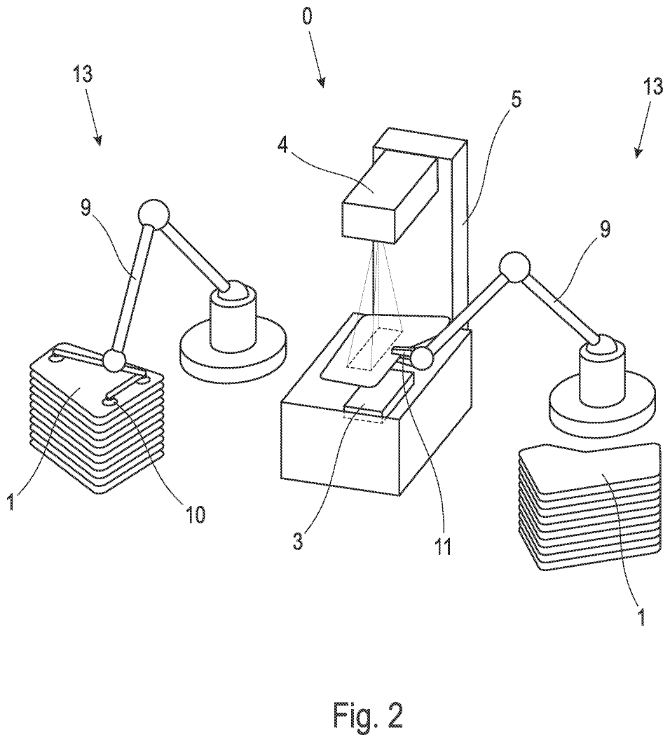

A significant advantage of a device according to the invention is that a vehicle interior trim part 1 to be processed, which is held in the working plane A, only needs to be roughly positioned. Rough positioning means here that the predetermined breaking line 2 to be produced need only lie within the field of view of the camera and within the scan field of the laser scanning device. This makes it possible to hold the vehicle interior trim part 1 in the working plane A, e.g. using a multi-axis robot 9, see FIG. 2, instead of placing it in a part-specific holding device, with which a higher positioning accuracy is achieved. It is also possible to pick up the vehicle interior trim part 1 less precisely, for example with suction cups 10, which is particularly advantageous for holding larger vehicle interior trim parts 1, compared to a gripper 11. The camera 8 has the function of optically recording the vehicle interior trim part 1, which is only roughly positioned in the working plane A, in order for the computing and control unit 5 to determine an actual position for the vehicle interior trim part 1 and derive an actual position for the predetermined breaking line from the image data obtained. The desired position of a scan figure (predefined processing coordinates) stored for a desired position of the predetermined breaking line is corrected to an actual position (corrected processing coordinates) and the laser scanning device 6 is controlled in the actual position of the vehicle interior trim part 1 to execute the scan figure along the predetermined position of the predetermined breaking line. For this purpose, the relative position of the vehicle interior trim part 1 in the camera coordinate system and thus relative to the scanner coordinate system is determined from the image data. To this end, defined features on the vehicle interior trim part 1, to which the predetermined breaking line 2 has a known fixed positional relationship, are determined in the image data.

Advantageously, the computer and control unit 5 can store not only one scan figure but several scan figures, each related to a desired position or also related to different desired positions of a predetermined breaking line to be produced.

The device can therefore be used for various vehicle interior trim parts that differ in the position and contour of the predetermined breaking line.

Using the device to form the predetermined breaking line 2 in the vehicle interior trim part 1 exactly at the predetermined position, even though the vehicle interior trim part 1 was only roughly positioned when it was arranged in the working plane A, is made possible by the use of the sensor matrix 3 in conjunction with image data-based control of the laser scanning device 6. The sensor matrix 3 has a homogeneous sensitivity, which was preferably adjusted by electronically tuning the sensitivity of the individual sensors of the sensor matrix 3 to each other. As a result, an identical comparative value is formed for an identical residual wall thickness, regardless of the number and position of the individual sensors that supply a measured value.

A diffuser 12 is arranged upstream of the sensor matrix 3. The portion of the laser beam transmitted at the individual processing locations during the production of the predetermined breaking line 2 (also to be understood here as secondary radiation caused by the laser beam at the processing location) is scattered by the diffuser 12 and is therefore distributed over a larger number of individual sensors than if no diffuser were arranged upstream.

A device 0 according to the invention is particularly suitable for installation in a production line, since it is compatible with a wide variety of feeding means or feeders 13 due to its low requirements for the positioning accuracy of the vehicle interior trim part to be processed with respect the device.

Together with at least one feeding means 13, preferably two, it forms a processing system, see FIG. 2, in which a vehicle interior trim part 1 is alternately removed from a stack by the feeding means 13 and transported into the working plane A of the device for producing a predetermined breaking line 2.

Particularly high flexibility in movement is provided if the feeding means 13 include a multi-axis robot 9, which holds the vehicle interior trim parts 1 suspended in the working plane A in each case.

In a method according to the invention for producing a predetermined breaking line in a vehicle interior trim part 1, the vehicle interior trim part 1 is picked up and arranged in a working plane A between a sensor matrix 3 and a processing head 4 arranged in a defined manner with respect thereto and containing a laser scanning device 6.

The laser scanning device 6 directs a laser beam S to an inner side of the vehicle interior trim part and scans said laser beam S, describing a scan figure, along the predetermined breaking line 2. This causes material to be removed in the form of holes, down to a predetermined residual wall thickness in each case, at a plurality of processing locations along the predetermined breaking line 2. With increasing material removal, the residual wall thickness at each processing location decreases until individual sensors of the sensor matrix detect transmitted components of the laser beam during material removal and record measured values.

A comparative measured value is formed from the measured values acquired simultaneously by each individual sensor of the sensor matrix and compared with a reference measured value to which the predetermined residual wall thickness is assigned.

This means that, regardless of the location, each of the individual sensors which provide a acquired measured value form an identical comparison value when the same residual wall thickness is reached at the respective processing location.

A laser generator 7 emitting the laser beam S is controlled as a function of a comparison result between the comparison value and the reference value. Controlling here can mean that the laser generator is switched off or that the laser parameters, e.g. a pulse length or a pulse amplitude, are changed.

The measured values of all individual sensors that lie above a predefined threshold value are acquired, which means that the predetermined breaking line can be positioned as desired within a field of view of the sensor matrix. However, knowledge of the rough positioning of the vehicle interior trim part also allows conclusions to be drawn about the area of the sensor matrix in which individual sensors will supply a measurement signal, which means that not all individual sensors have to be read out.

Whereas in the case of exact positioning of the vehicle interior trim part relative to a laser scanning device, as is usual in the prior art, the predetermined breaking line is arranged in a desired position, so that a scan figure stored for this purpose describes the predetermined breaking line, in the present case, according to the invention, the desired position of the scan figure stored for the desired position of the predetermined breaking line is corrected to an actual position for the scan figure assigned to the concrete actual position.

For this purpose, the actual position of the vehicle interior trim part relative to the laser scanning device is optically acquired by a camera and the actual position of the predetermined breaking line relative to the laser scanning device is derived therefrom.

A desired position of the scan figure stored for the desired position of the predetermined breaking line is corrected to an actual position of the scan figure, thereby aligning the scan figure with the predetermined breaking line.

The process is advantageously carried out on three vehicle interior trim parts with a time overlap, arranging the vehicle interior trim parts one after the other in the working plane by means of two of the feeding means.

In this case, the first of the three vehicle interior trim parts is preferably processed while held in the first of the two feeding means, while the second feeding means transports the finished second vehicle interior trim part to an output location, and then the third vehicle interior trim part, which has not yet been processed, is picked up at an input location and transported for processing.

Ideally, the sensor matrix is homogeneous in sensitivity over its extent. This can be optimized by scattering the transmitted part of the laser beam, which means that more individual sensors detect transmitted parts and record measured values, thus relativizing any fluctuation.

### LIST OF REFERENCE NUMERALS

0 device (for producing a predetermined breaking line)
1 vehicle interior trim part
2 predetermined breaking line
3 sensor matrix
4 machining head
5 control and computing unit
6 laser scanning device
7 laser generator
8 camera
9 multi-axis robot
10 suction cup
11 gripper
12 diffuser
13 feeders or feeding means
A working plane
S laser beam

1. A method for producing a predetermined breaking line in a vehicle interior trim part, comprising:
picking up and arranging a vehicle interior trim part in a working plane between a sensor matrix and a processing head containing a laser scanning device,
scanning a laser beam, using the laser scanning device, on an inner side of the vehicle interior trim part, describing a scan figure, along the predetermined breaking line, wherein material removal in the form of holes is effected in each case down to a predetermined residual wall thickness at a plurality of processing locations along the predetermined breaking line and measured values are acquired by individual sensors of the sensor matrix during the material removal caused by a portion of the laser beam transmitted at the processing locations,
forming a respective comparative measured value from measured values acquired simultaneously and comparing with a reference measured value to which the predetermined residual wall thickness is assigned, and
controlling a laser generator to emit the laser beam as a function of a comparison result,
acquiring measured values of all individual sensors that lie above a predefined threshold value so that the predetermined breaking line can be positioned as desired within a field of view of the sensor matrix,
optically detecting an actual position of the vehicle interior trim part relative to the laser scanning device and deriving from the actual position of the vehicle interior trim part an actual position of the predetermined breaking line relative to the laser scanning device, and
correcting a desired position of a scan figure stored for a desired position of the predetermined breaking line for scanning the predetermined breaking line to an actual position of the scan figure, and
producing the predetermined breaking line at a predetermined position on the vehicle interior trim part during scanning of the scan figure.

2. The method for producing a predetermined breaking line in a vehicle interior trim part according to claim 1, wherein:
the method is carried out on three vehicle interior trim parts with a time overlap, and the method further comprises arranging the vehicle interior trim parts one after the other in the working plane by two feeders and determining an actual position of the scan figure individually for a respective actual position of the respective vehicle interior trim part.

3. The method for producing a predetermined breaking line in a vehicle interior trim part according to claim 2, wherein:
a first of the three vehicle interior trim parts is processed while held in a first of the two feeders, while the second feeder transports the finished second vehicle interior trim part to an output location, and then the third vehicle interior trim part, which has not yet been processed, is picked up at an input location and transported for processing.

4. The method for producing a predetermined breaking line in a vehicle interior trim part according to claim 1, wherein the transmitted part of the laser beam is scattered so that measured values can be acquired by more individual sensors.

5. A device for producing a predetermined breaking line in a vehicle interior trim part, comprising:
a sensor matrix,
a diffuser,
a camera,
a laser generator,
a processing head arranged in a defined manner with respect to the sensor matrix and an intermediate working plane, said processing head containing a laser scanning device, which is connected to the laser generator, in which the vehicle interior trim part to be processed is arranged, and
a control and computing unit, wherein:
a field of view of the sensor matrix is larger than a maximum extension of the predetermined breaking line,
the camera is directed towards the working plane, and is configured to detect an actual position of the vehicle interior trim part arranged in the working plane in relation to the laser scanning device, from which an actual position of the predetermined breaking line is derived therefrom, and
the control and computing unit is configured to bring the scan figure into alignment with the predetermined breaking line, and
the diffuser is arranged upstream of the sensor matrix.

6. The device for producing a predetermined breaking line in a vehicle interior trim part according to claim 5, wherein individual sensors of the sensor matrix each have a sensitivity that is matched to each other so that the sensor matrix has a homogeneous sensitivity.

7. A processing system comprising a device for producing a predetermined breaking line in a vehicle interior trim part according to claim 5, the processing system including at least two feeders by which a vehicle interior trim part is alternately transported and positioned in the working plane of the device for producing the predetermined breaking line.

8. The processing system according to claim 7, wherein the at least two feeders include multi-axis robots which hold the vehicle interior trim parts suspended in the working plane in each case.
